(19) United States
(12) Patent Application Publication
(10) Pub. No.: US 2020/0286323 A1
(43) Pub. Date: Sep. 10, 2020

(54) METHOD FOR OPERATING AN ELECTRONICALLY REGULATED RETURN SYSTEM

(71) Applicants: FRANZ WIETH, PUCHHEIM (DE); ANDREAS FILOSI, PUCHHEIM (DE)

(72) Inventors: FRANZ WIETH, PUCHHEIM (DE); ANDREAS FILOSI, PUCHHEIM (DE)

(21) Appl. No.: 16/759,572

(22) PCT Filed: Oct. 24, 2018
(86) PCT No.: PCT/EP2018/079220

§ 371 Date: Apr. 27, 2020

(30) Foreign Application Priority Data
Oct. 26, 2017 (DE) 10 2017 125 074.3

(51) Int. Cl. G07F 7/06; G06Q 20/32

(52) U.S. Cl. CPC G07F 7/0672; G06Q 20/3278

(57) ABSTRACT

A method for operating an electronically controlled return system for loaned or borrowed objects, in particular for transport carriages which can be moved by hand. The borrowed object is rigidly connected to a communication module which receives a wirelessly transmitted first signal A of a transmission device at a collection point. The communication module evaluates a position and/or location of the borrowed object and uses the first signal A in order to determine the position and/or location of the borrowed object relative to the transmission device. There is also described an electronically controlled return system, in particular for operating the method.

The invention relates to a method for operating an electronically regulated return system for loaned objects, in particular for hand movable trolleys.

Hand movable trolleys, e.g., shopping carts at a supermarket, are often equipped with deposit locks. In this way, they can be gathered together at a collection site and fixedly connected with each other by means of a chain with key. This requires that the trolleys be “nested” in an orderly fashion, i.e., that shopping carts be properly slid one into the other in a row. The deposit locks here make it possible to fixedly connect the respective first trolley in the row by means of a chain and key with a collection site, e.g., a shopping cart garage. Additional shopping carts are slid into the latter, and connected with each other by means of their deposit lock. A coin, a chip in the form of a coin or a special card serves as the deposit for decoupling the key with chain. Anyone who wishes to use a shopping cart on a loan basis must use one of these release means.

In order to avoid such a deposit lock, while still ensuring that the user will bring the trolley back to the collection site in an orderly fashion after removal and use, there are fixedly installed systems that lock or function as barriers and prevent an unauthorized removal of the trolley without a usage fee or deposit.

The disadvantage to the latter is that a high investment outlay is required for installing such systems. In addition, once equipped with such a rigid, central system, this type of collection site is inflexible, and can only be transferred to another location at great expense. However, release means as a deposit or usage fees, such as coins or cards, are still required for these systems in order to open the lock.

As an alternative to coins or cards as the deposit for a deposit system, use can also be made of a reward system, such that the user of a trolley receives a reward as an incentive for bringing back the trolley. This reward can take a variety of forms. (Bonus points, rebates, participation in a sweepstake, etc.). Reward systems like these are known.

The disadvantage to the latter is that the reward is not generated electronically by a device on the trolley, thus requiring an additional device for the reward, such as an automatic dispenser.

Another disadvantage is that an orderly nesting of trolleys cannot be ensured without additional equipment at the collection site.

The object of this invention is to propose an alternative method to a deposit lock solution for a return system, which ensures an orderly nesting of borrowed objects at the collection site.

This object is achieved with the method for operating an electronically regulated return system according to claim 1. Several of the embodiments advantageous for this purpose are summarized in the claims that are dependent on claim 1. One core idea of the invention is that the loaned object be fixedly connected with a communications module, which receives a wirelessly transmitted first signal A of a transmission means of a collection site, wherein the communications module comprises a means for evaluating the position and/or location of the loaned object, which uses the first signal A for determining the position and/or location of the loaned object relative to the transmission means.

Within the meaning of this application, for example, a loaned object is an object made available to the customer by a business for shopping purposes. One example for the above is a hand movable trolley, in particular a shopping cart. In this conjunction, the collection site could be the shopping cart garage belonging thereto. A different example involves a basket, which is made available to the customer of a business for shopping purposes, and can be returned after shopping to a collection site, for example in the checkout area. Another object made available for shopping purposes is the mount handed out by the business for a communications terminal that is available to the user.

Depending on the design of the reception means, the position and/or location can be determined by measuring the signal strength and/or bearing of the transmission means of the collection station. In an especially simple embodiment, an antenna in the form of a frame can be used for this purpose. In order to be able to determine the location of the loaned object even better, parts of the antenna are preferably shielded in specific directions. In particular for determining location, alternative embodiments use two or more communications modules spaced apart from each other or a communications module with spaced apart antennas. If the position and/or location of the loaned object in relation to the collection site is known, this can be used to determine whether the loaned object is parked at the collection site.

It is likewise possible to provide a plurality of transmission means at a collection site that transmit a first signal A, which are spaced apart from each other. This allows the communications module to determine its location even more precisely via triangulation. It is advantageous that the transmission means be provided by the communications module. This makes it possible to design the method or system as uniformly as possible.

Given a collection site at which the loaned objects are returned in rows, it is advantageous that a transmission means be prescribed per row. This makes it possible to better determine the location of the loaned object, and even to prescribe a specific position by the exact row. In this way, individual rows can also be prevented from getting too long, and thereby protrude at the collection site, while other rows still have space. In an especially preferred embodiment, each of these transmission means transmits a first signal A with a varying content or frequency, so that a transmission means can be allocated to a specific row.

It is significant that the loaned object and the communications module are to be allocated to each other. For some of the preferred embodiments, it is further required that the position and location of the communications module in relation to the loaned object be known. This is easiest to accomplish when the communications module is fixedly connected with the loaned object. In the sense of this application, fixed also means that a separation of the connection by the user or customer is not provided. A permanent connection is here especially advantageous, so that no further allocation of the communications module to the loaned object is required.

In particular in a communications module fixedly and preferably permanently connected with the loaned object, an energy storage system is to be provided, which provides the energy required for operating the communications module. Such an energy storage system can be charged externally, preferably without a cable via induction charging, so that no contacts are required for this purpose. Another advantageous solution involves exclusive or additional charging by means of a photovoltaic element provided on the loaned object, for example on a shopping cart handle. If the loaned object is used in a building, it is advantageous that the photovoltaic element be optimized to the light temperature and/or illuminance of the lighting inside of the building. This is usually colder than or not as strong as normal sunlight.

A microgenerator is suitable for this purpose as an alternative or complement.

In addition to the energy storage system, the communications module should have a computing unit and a data storage. This enables the supplier or user of the return system to program the communications module for the respectively present boundary conditions. In this way, it is also possible to allocate a clear, in particular individualized identifier to the communications module.

In particular BLE (Bluetooth low energy) is suitable as the wireless technology. The range for the radio signals achievable therewith is sufficient for most applications of the method, and requires little energy for operation. In addition, given a known transmission strength of the transmission means, measuring the signal strength of the received signals enables a distance determination, which can be drawn upon for determining the location.

In a preferred embodiment, the communications module wirelessly transmits a second signal B to a communications terminal of a user, in particular to a telecommunications terminal. In this embodiment, the communications module thus also has a transmission means. If the communications module has reception and transmission means, it can be used not just on the loaned object, but rather at the collection site for transmitting the first signal A. This makes it possible to cost-effectively equip the return system with structurally identical modules.

The second signal B can be used to transmit information to the user of the loaned object via their telecommunications terminal, in particular their smartphone. It is especially advantageous that the content of the second signal B depend on the respective position and/or location of the loaned object. This preferably enables a configuration in which the second signal B contains data that trigger a reward and/or invoice and/or credit if the loaned object assumes a specific position and location at the collection site.

In this embodiment of the data of the second signal B, it is especially advantageous that the data of the second signal B be transmitted via near-field communication (NFC) to the telecommunications terminal. This necessitates that the user of the loaned object hold their telecommunications terminal close to the communications module or its transmission means so as to receive the transmitted bonus.

By contrast, other users present in the area of the collection site are located outside the signal range, and cannot receive the second signal B. This ensures that only the authorized user receives the transmitted bonus.

In another embodiment, the second signal B can contain data that comprise information about a specific position and location of the loaned object to be achieved if the loaned object has not yet assumed the specific position. In this way, the returners of the loaned object can have transmitted or displayed to them not just assistance during the return, but also a bonus.

In an alternative or supplementary embodiment thereto, data of the second signal B are transmitted to a receiver allocated to the collection station, which then transmits the data to the user in an image and/or voice output. For example, this can be a screen via which the user receives assistance for correctly returning the loaned object.

It is especially advantageous that the communications module have a gyro sensor. Such a sensor detects an acceleration of the communications module. It can be used to reduce the energy requirement of the communications module. If no acceleration is determined over a specific period of time, it can be assumed that the communications module, and hence the loaned object connected with it, is not being moved. One example for the latter is if the loaned object has been parked at the collection site. In this case, the frequency with which the communications module transmits a signal can be reduced or even eliminated entirely until a renewed movement is detected.

In an alternative or supplementary embodiment thereto, the communications module has a compass module. Such a compass module can be a digital magnetometer. The compass permits an orientation in the direction that can be used to determine the location of the communications module. Furthermore, this makes it possible to prescribe a specific alignment of the collection site in the communications module, for example that a row at the collection site is aligned in a 240° direction. Alternatively, it can be provided that such a directional indication be integrated into the first signal A.

It is here advantageous if the compass module along with the other means of the communications module can be assembled on a circuit board. This makes it possible to install the communications module as a unit protected against influences arising from outside, for example weather conditions, vandalism, influences during cleaning operations, etc., which is preferably readily accessible from outside for maintenance, repair, or replacement work.

Combining the gyro-sensor with the compass module makes determining the location especially easy.

It is also especially advantageous that the telecommunications terminal be linked with the loaned object by means of an NFC connection, and that the linkage be checked before transmitting the data of the second signal B, which triggers a reward and/or invoice and/or credit. This makes it possible to distinguish between a user bringing back the object they borrowed and some other person, for example who brings shopping carts left standing at a different location back to the collection site. The distinction enables a differentiated reaction, for example an adjustment of the bonus given.

An alternative thereto involves a linkage via BLE, which ensures that the communication partners are clearly allocated, in particular that the communication only takes place between the communications module and the communications terminal of the loaned object linked thereto.

In an especially preferred embodiment, the communications module wirelessly transmits a third signal C, based on which a communications module of a second loaned object determines the position and/or location of the second object relative to the first object. In this way, the communications module of a first loaned object can determine its location assisted by the communications modules of other loaned objects. For example, the third signal C can be used to detect whether several shopping carts are nested in a row. In addition, the communications modules can act as quasi relay stations for first signals A transmitted from the collection site. The communications modules are thus basically enabled to communicate without contact, and if necessary exchange and store data. For this purpose, the communications module of a loaned object can advantageously identify itself to the other communications means, for example by transmitting an ID.

It is advantageous that the transmission means of the collection site be arranged at one end of the collection site. The end refers to the area of the collection site boundary up to which a loaned object can be maximally placed or inserted at the collection site. For example, based on the signal strength, the communications module of a loaned object can detect that the loaned object was parked, e.g., at the end of the collection site. An identifier defining this status can correspondingly be appended to the third signal C. A communications module of the loaned object placed behind it receives the third signal C with the identifier. In particular by measuring the signal strength, it can determine the distance to the communications module transmitting the identifier, and thereby detect whether its loaned object was placed deeply enough in the collection site. Furthermore, it can provide the third signal C transmitted by it with its own identifier, which defines the space viewed from the end of the collection site, for example the second space. This scheme can also be applied for all loaned objects placed in the collection site. The identifier can thus be used as a counter, which defines the sequence at the collection site and/or the space in the sequence.

One special advantage here is that this makes it possible to detect that additional loaned objects were placed in the collection site. This is the case when a communications module transmitting an identifier with a lower counter receives a third signal C, which has an identifier with a higher counter. The communications module can then set the transmission of its identifier with the lower counter, and thereby save energy.

Another advantage to this identifier is that the maximum length for a row of loaned objects can hereby be prescribed. If a collection site has reached the maximum fill level of loaned objects arranged in sequence, a different row, possibly even a different collection site, can be allocated to the next returner of a loaned object.

If the communications module has two antennas spaced apart from each other in the lateral direction or if two correspondingly arranged communications modules are provided per loaned object, the distance between two loaned objects placed one behind the other in the same row at a collection site can thus be determined. To this end, it is necessary that the third signals C transmitted by the spaced apart antennas or the communications modules contain a definition of their lateral position. Given an antenna positioned on the left side of the loaned object or a communications module positioned on the left, the third signal C transmitted from there must contain a feature characterizing it as a signal from the left. This applies analogously for the antenna or communications module on the right side. IF the distance between the antennas arranged on the right and left or the communications modules arranged on the right and left is stored, the distance to the antennas or communications modules of the next loaned object arranged on the right and left can be calculated via triangulation with the received signal strength.

In this way, for example, the alignment of a shopping cart relative to the shopping carts already placed at the collection site can be determined. This is the case when the signal strength between the left third signal C of the rear shopping cart and right third signal C of the front shopping cart correspond within a specific tolerance to the signal strength between the right third signal C of the rear shopping cart and left third signal C of the front shopping cart. In addition, it can be determined whether a shopping cart was correctly nested, i.e., inserted deeply enough into the shopping cart standing in front of it. This is the case if both of the signal connections described above reach a specific minimum strength.

Furthermore, it can be determined whether the shopping cart was inserted into the collection site the wrong way around. This is the case if the signal strength between the left antennas or communications modules of two shopping carts is less than the signal strength between the right antennas or communications modules of these shopping carts.

In most cases, measuring the signal strength of two signal pairs already makes it possible to determine a proper nesting. However, it is especially advantageous that not just the signal strength of two signal pairs be measured, meaning the connection between the right signal C of a first shopping cart and left signal C of a second shopping cart, as well as the left signal C of a first shopping cart and right signal C of a second shopping cart or the connection between the right signal C of a first shopping cart and right signal C of a second shopping cart, as well as the left signal C of a first shopping cart and left signal C of a second shopping cart. The position and location can be determined far more precisely if the signal strengths of all four signal pairs are measured.

Naturally, the same also holds true for the first object placed at a collection site if transmission means arranged on the right and left transmit a first signal A defining their position instead of one transmission means.

Analogously to the aforementioned, the distance between two loaned objects placed in different rows of a collection site can be determined if the communications module has several spaced apart antennas or if several communications modules are provided per loaned object. This feature can likewise be drawn upon for determining the position and/or location.

It is likewise advantageous if an area, in particular the area of a business, wirelessly transmits a fourth signal D, which is received by the communications module of a loaned object when it is located in this area. In a preferred embodiment, this signal is transmitted by one of the communications modules described here, which makes it possible to use more common parts. The fourth signal D enables a determination as to whether the loaned object has traversed a specific area. Relative to a business, this area can be the checkout area, but also a specific department or even smaller sections. This in turn makes it possible to obtain knowledge about the areas traversed by the user of the loaned object, for example a shopping art.

As an alternative thereto, it is possible for a communications module to transmit a fourth signal D, and for the latter to be received by a reception site when the communications module is located in its area.

With respect to the amount of the reward and/or invoice and/or credit, it is here especially advantageous that the data output by means of the second signal B depend on whether the loaned object has traversed a specific area and/or how long it was located in a specific area and/or what sales are attributed to the user of the loaned object. For example, the sales can be determined via apps, which were made available to the customer for payment processing or self-scanning.

Another advantage to the system is that it can also be used by a customer without a smartphone. He or she is able to remove the loaned object without restriction from a collection site and return it following use. If he or she has a customer card or debit card with integrated nearfield communication, for example an NFC chip, the latter can be used to link the loaned object with the customer. In addition, it becomes possible to also credit the customer identified in this way with a bonus, for example via a bonus system such as payback.

The method or system proposed here is basically capable of functioning without the transmission means that transmits a first signal A. Even without the first transmission means, and even with no collection site, it is able to detect the gathering of loaned objects and determine their proper alignment to each other.

1-10. (canceled)

11. A method of operating an electronically regulated return system for loaned objects, the method comprising:
providing a loaned object with a fixedly connected communications module and receiving with the communications module a wirelessly transmitted first signal A of a transmission device of a collection site;
evaluating with the communications module a position and/or a location of the loaned object, and thereby using the first signal A for determining the position and/or the location of the loaned object relative to the transmission device.

12. The method according to claim 11, wherein the loaned object is a hand movable trolley.

13. The method according to claim 11, which comprises wirelessly transmitting with the communications module a second signal B to a communications terminal of a user, wherein a content of the second signal B depends on the respective position and/or the location of the loaned object.

14. The method according to claim 13, wherein the communications module of the user is a telecommunications terminal.

15. The method according to claim 13, wherein the second signal B contains data that trigger at least one of a reward, an invoice, or a credit if the loaned object assumes a specific position and location at the collection site.

16. The method according to claim 13, which comprises transmitting the data of the second signal B by way of short-range wireless technology to the communications terminal of the user.

17. The method according to claim 16, which comprises transmitting the data of the second signal B to the communications terminal of the user by way of a near field communications (NFC) signal.

18. The method according to claim 13, wherein the second signal B contains data with information about a specific position and location of the loaned object to be achieved if the loaned object has not yet assumed the specific position.

19. The method according to claim 13, which comprises linking the telecommunications terminal with the loaned object by way of short-range wireless technology, and checking a linkage before transmitting the data of the second signal, which triggers one of a reward, an invoice, or a credit.

20. The method according to claim 19, which comprises linking the telecommunications terminal with the loaned object by way of a near field communications (NFC) signal.

21. The method according to claim 13, which comprises wirelessly transmitting with the communications module a third signal C, based on which a communications module of a second loaned object determines the position and/or the location of the second object relative to the first object.

22. The method according to claim 21, which comprises wirelessly transmitting a fourth signal D in an area of a business, which is received by the communications module of a loaned object when the loaned object is located in the area.

23. The method according to claim 22, wherein the second signal B is configured to trigger at least one of a reward, an invoice, or a credit and a value of the reward, the invoice, or the credit depends on whether the loaned object has traversed a specific area and/or how long the loaned object was located within a specific area and/or what sales are attributed to the user of the loaned object.

24. An electronically controlled return system, comprising:
a collection site having a transmission device associated therewith;
a communications module fixedly connected with a loaned object;
said communications module having a receiver for receiving a wirelessly transmitted signal of said transmission device of said collection site;
said communications module having a transmission device for transmitting a signal to a communications terminal of a user returning the loaned object at the collection site and/or to a receiver of a communications module fixedly connected with another loaned object.

25. The system according to claim 24, wherein the communications terminal of the user is a telecommunications terminal.

26. The system according to claim 24, configured for implementing the method according to claim 11.
